(19) United States
(12) Patent Application Publication
(10) Pub. No.: US 2005/0171245 A1
(43) Pub. Date: Aug. 4, 2005

(54) Decorative wood composite products and adhesive compositions

(76) Inventors: Jianwen Ni, Loganville, GA (US); Charles R. Davis, Conyers, GA (US); Robert A. Breyer, Tucker, GA (US)

Correspondence Address: BANNER & WITCOFF, 1001 G STREET N W, SUITE 1100, WASHINGTON, DC, 20001, US

(21) Appl. No.: 10/766,531

(22) Filed: Jan. 29, 2004

(51) Int. Cl. C08L 1/00

(52) U.S. Cl. 524/13

(57) ABSTRACT

Adhesive compositions useful for making decorative wood composite products contain a surfactant, particularly a neutralized tall oil fatty acid, and a thermosetting resin. Use of such adhesive compositions significantly reduces the incidence of surface pinholes in the products while using a smaller amount of the resin.

### FIELD OF THE INVENTION

The invention relates to decorative wood composite products, improved methods of making the products, and adhesive compositions useful for making the products.

### BACKGROUND OF THE INVENTION

The occurrence of pinholes in decorative wood composite products is a concern because pinholes interfere with the aesthetics of the ultimate surface-laminated or surface-coated product destined, for example, for furniture applications. Approaches used in the prior art to reduce the occurrence of pinholes increase the overall product cost. For example, one solution was to increase the level of adhesive used to make the product. Another approach was to make the product thicker to allow for more sanding of the surface to yield a suitable degree of smoothness at a suitable, resulting product thickness.

There is a need in the art to reduce the occurrence of pinholes in decorative wood composite products without the expense of the prior art methods.

### BRIEF SUMMARY OF THE INVENTION

The invention provides at least the following embodiments.

The invention provides a decorative wood composite product. The product comprises a wood composite product having a face layer and a decorative overlay affixed to the face layer. The face layer comprises wood pieces bonded together with a thermosetting resin that contains a surfactant.

The invention provides an improved method of making a decorative wood composite product which comprises a face layer and a decorative overlay. The improvement comprises bonding wood pieces in the face layer together with a thermosetting resin containing a surfactant.

The invention also provides an adhesive composition suitable for bonding wood pieces together. The adhesive composition comprises a thermosetting resin, an amine, and a tall oil fatty acid.

### BRIEF DESCRIPTION OF THE DRAWING

FIG. 1. Effectiveness of surfactants. X-axis, surfactant level (%); Y-axis, surface tension (normalized).

### DETAILED DESCRIPTION OF THE INVENTION

The invention provides decorative wood composite products, improved methods of making the decorative wood composite products, and adhesive compositions useful for making the decorate wood composite products. The invention is based on the discovery that adding a surfactant, particularly a neutralized tall oil fatty acid, to a thermosetting resin used to make wood composite products significantly reduces the incidence of surface pinholes in the products while using a smaller amount of the resin. In addition to reducing or eliminating surface pinholes, surfactants of the invention have been shown to eliminate resin-wood build up on forming lines and also have the potential to eliminate or reduce platen build up.

Adhesive Compositions

One embodiment of the invention provides adhesive compositions useful for making decorative wood composite products. Adhesive compositions of the invention comprise a thermosetting resin, a surfactant (e.g., a tall oil fatty acid) and, optionally, an amine, such as triethylamine.

Thermosetting Resin

A “thermosetting resin” is any synthetic resin in an initial stage of polymerization which is convertible by heat to the insoluble, infusible state. Thermosetting resins are available from commercial suppliers, such as Georgia Pacific, Borden, Biolar, and Chimar Hellas.

Thermosetting resins useful in the present invention can be, for example, amino resins, phenolic resins, or mixtures of amino and/or phenolic resins. Useful amino resins include melamine-formaldehyde resin, urea-formnaldehyde resins (e.g., RUUB 729064), and mixtures thereof. Useful phenolic resins include phenol-formaldehyde resins (e.g., phenolic resole resins), phenol-acetaldehyde resins, resorcinol-formaldehyde resins, phenol-furfural resins, and mixtures thereof. Examples of phenols are phenol, cresol, and xylenol.

Preparation of amino resins is described, for example, in U.S. Pat. Nos. 4,083,830, 5,998,573, and 6,610,818. Urea-formaldehyde resin, obtained by the condensation of urea with formaldehyde in an alkaline environment, are a preferred type of thermosetting resin. Methods of preparing urea-formaldehyde resins are well known in the art. See, e.g., U.S. Pat. Nos. 2,260,033, 2,626,251, 3,882,462, 3,804,706, 4,492,699, 4,968,773, 5,362,842, and 5,674,971.

Formaldehyde is available in many forms. Paraform (solid, polymerized formaldehyde) and formalin solutions (aqueous solutions of formaldehyde, sometimes with methanol, in 37 percent, 44 percent, or 50 percent formaldehyde concentrations) are commonly used forms. Formaldehyde also is available as a gas. Any of these forms is suitable for use in the practice of the invention. Typically, formalin solutions are preferred as the formaldehyde source. Formaldehyde-yielding substances include formaldehyde, paraformaldehyde, and hexamethylenetetramine.

Similarly, urea is available in many forms. Solid urea, such as prill, and urea solutions, typically aqueous solutions, are commonly available. Further, urea may be combined with another moiety, most typically formaldehyde and urea-formaldehyde, often in aqueous solution. Any form of urea or urea in combination with formaldehyde is suitable for use in the practice of the invention. Both urea prill and combined urea-formaldehyde products are preferred, such as Urea Formaldehyde Concentrate or UFC 85. These types of products are disclosed in, for example, U.S. Pat. Nos. 5,362,842 and 5,389,716.

Surfactant

The surfactant preferably is an aliphatic hydrocarbon comprising at least 6 carbon atoms, such as an alcohol (e.g., cetyl alcohol) or a fatty acid (e.g., a tall oil fatty acid). Other useful surfactants include, but are not limited to, oleic acid, acetylated sucrose diester, ethylene glycol distearate, acetylated monoglyceride, sorbitan trioleate, glycol dioleate, and mixtures thereof.

The amount of surfactant used preferably is sufficient to reduce the surface tension of the thermosetting resin lower than the surface energy of wood. If not enough surfactant is used, the resin will not spread evenly over the product surface. If too much surfactant is used, it will add additional cost without providing an additional benefit. The surfactant preferably is added to a thermosetting resin at a concentration of about 0.01 to about 5%, preferably about 0.1% to about 1%, based on the resin's liquid weight.

Tall oil fatty acids

Tall oil fatty acid acids (TOFA) are the components of tall oil produced by refining tall oil to separate tall oil rosins from the lighter molecular weight tall oil fatty acids. Typically, the percentage of fatty acids in a TOFA mixture is greater than about 85%. TOFA mixtures are commercially available from a number of refiners such as Georgia Pacific, Arizona Chemical Company, Hercules, Monsanto-Emery, Reichhold, Sylvachem, Union Camp, and Westvaco.

Optional Amine

The surfactant optionally can comprise an amine, such as triethanolamine or triethylamine. If an amine is included, the amine and the aliphatic hydrocarbon typically are present in a molar ratio of about 0.5 to about 1.5 (amine:acidic hydrocarbon), optionally about 1:1. In some embodiments, surfactants comprise an acidic aliphatic hydrocarbon, such as a TOFA or a TOFA mixture, and an amine (e.g., triethylamine). If a tall oil fatty acid is used in conjunction with the amine, the amine and the tall oil fatty acid typically are present in an equivalent weight ratio of about 0.5 to about 1.5 or about 1:1. For example, in one embodiment a surfactant contains about 20 parts per weight TOFA (e.g., XTOL100, having an equivalent weight of 289.2) and about 7 parts per weight triethylamine (molecular weight 149.19).

The amine can be mixed with the acidic aliphatic hydrocarbon to form the surfactant. Alternatively, the separate components (amine and acidic aliphatic hydrocarbon) of the surfactant can be added directly to a thermosetting resin.

In some embodiments of the invention, an amine with a low boiling point is used, so that the surfactant is a transient surfactant. Heat then evaporates the amine and deactivates the surfactant, which provides an additional advantage in that wood composite products made with such thermosetting resins are more resistant to swelling. Triethylamine is useful, although any volatile amine can be used.

Wood Composite Products

“Wood composite products” as used herein are products made from wood pieces, such as wood wafers, wood strands, wood particles, sawdust, wood chips, wood flakes, wood fibers, and the like. Any type of wood used in the art to make such products can be used in wood composite products of the invention. These woods include both hardwoods and softwoods, such as pine, spruce, fir, poplar, alder, cedar, or mixtures thereof, including recycled wood.

Wood composite products of the invention have a face layer made of such wood pieces bonded together with an adhesive composition of the invention (i.e., a thermosetting resin that contains a surfactant). A decorative overlay is affixed to the face layer. In a preferred embodiment, wood pieces in the face layer are bonded together using a thermosetting resin containing about 0.1% of a surfactant containing a tall oil fatty acid and triethylamine in an equivalent weight ratio of about 1:1.

Decorative Overlay

Any suitable decorative overlay can be used in wood composite products of the invention. Decorative overlays include, but are not limited to, paper, melamine resin-saturated paper, fabric, metal foil, and polyester films (e.g., mylar).

Methods of Making Decorative Wood Composite Products

The invention also provides improved methods for making decorative wood composite products. Preparation of composite wood products, e.g., particleboard, is well known in the art. See, e.g., U.S. Pat. No. 6,599,455; Ernst Deppe, Taschenbook der Splanplattentechnik, 3rd ed., 1991. Any such methods can be adapted for use with adhesive compositions of the invention, which simply is substituted for the thermosetting resin ordinarily used to prepare the face layer of composite wood products. Use of such compositions in the face layer of composite wood products thereby reduces the occurrence of pinholes in the face layer and reduces the amount of thermosetting resin used to make the product.

All patents, patent applications, and references cited in this disclosure are expressly incorporated herein by reference. The above disclosure generally describes the present invention. A more complete understanding can be obtained by reference to the following specific examples, which are provided for purposes of illustration only and are not intended to limit the scope of the invention. EXAMPLE 1

One-half inch particleboard made with RUUB 729D64 as the face resin (“control resin”) was compared with one-half inch particleboard made with RUUB 729D64 containing 0.1% surfactant (0.74% tall oil fatty acid and 0.26% triethylamine) (“trial resin”) using a Tinius Olsen, Model H5kS test machine. The press cycle time was maintained at 137 seconds. The results are shown in Table 1, below.

TABLE 1

| | | Results | | |
|---|---|---|---|---|
| Face | % Face | Internal | Modulus of | Modulus of |
| Resin | Resin | Bonds | Rupture | Elasticity |
| trial | 7.48-7.65 | 105-119 | 2182-2379 | 320-329 |
| resin | | | | |
| control | 7.46-7.73 | 105-127 | 2215-2337 | 323-345 |
| resin | | | | |

These results demonstrate that a wood composite product made using as the face resin a thermosetting resin of the invention performs as well in typical quality control tests as a wood composite product made using a conventional face resin. In addition, the occurrence of pinholes was reduced in particleboard made using the trial resin.

In another experiment, a one-half inch particleboard was manufactured using the trial resin at a concentration 10-12% less than the amount of face resin conventionally used to manufacture particleboard. Properties of this particleboard were comparable to those shown in Table 1. This experiment demonstrates that a wood composite product of comparable quality can be made using a lower amount of a thermosetting resin if a surfactant is included in the resin.

### EXAMPLE 2

This example demonstrates that a reduction in resin usage of 8 lb/MSF ¾ basis (˜5%) can be achieved using an adhesive composition of the invention.

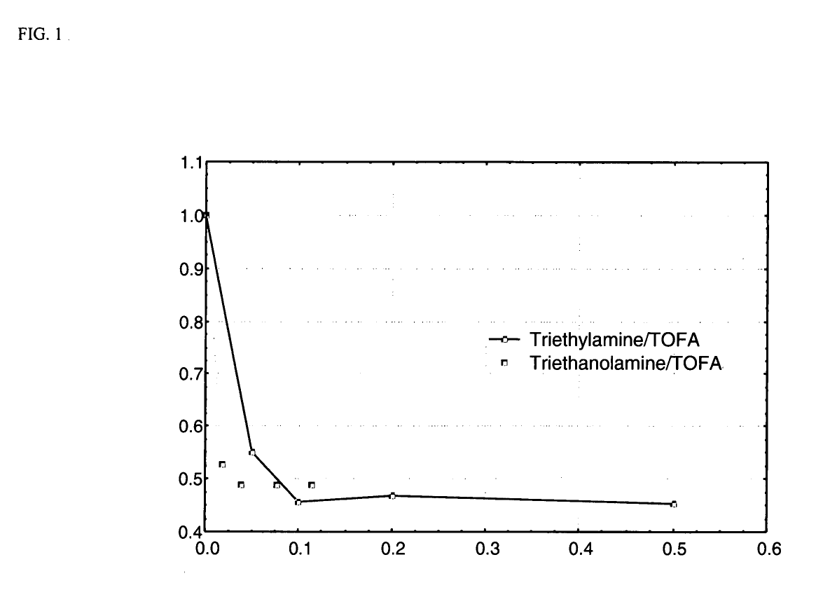

The trial covered 30 days of production. The two resins (with and without surfactant) were alternated every 8 hours, with the changeover at mid-shift to avoid bias. Panel properties and resin consumption data were collected and analyzed. The results are shown in Tables 2, 3, and 4, and in FIG. 1.

TABLE 2

| | Surfactant resin | Control resin | Difference |
|---|---|---|---|
| | Lbs/M ft² | Lbs/M ft² | Lbs/M ft² |
| Product | ¾″ basis | ¾″ basis | ¾″ basis |
| 0.375″ Microfines | 155.5 | 163.5 | 8.0 |
| 0.50″ Microfines | 124.8 | 128.6 | 3.8 |
| 0.625″ Microfines | 128.2 | 146.3 | 18.1 |
| 0.625″ Cab Core | 104.0 | 103.5 | −0.5 |
| 0.75″ Microfines | 134.3 | 138.9 | 4.6 |
| 0.75″ Underlayment | 103.4 | 111.7 | 8.3 |
| 0.75″ Cab Core | 92.9 | 103.6 | 10.7 |
| 1.125″ Microfines | 127.6 | 133.4 | 5.8 |

TABLE 3

| | | Panels | Defective | Grade |
|---|---|---|---|---|
| Product | Resin | Sanded | Panels | Out % |
| 0.3875″ Microfines | Surfactant | 35035 | 815 | 99.977 |
| 0.3875″ Microfines | Non-surfactant | 31530 | 660 | 99.979 |
| 0.625″ Microfines | Surfactant | 12375 | 210 | 99.983 |
| 0.625″ Microfines | Non-surfactant | 11096 | 198 | 99.982 |
| 0.625″ Cab Core | Surfactant | 7790 | 82 | 99.989 |
| 0.625″ Cab Core | Non-surfactant | 3125 | 33 | 99.989 |
| 0.75″ Microfines | Surfactant | 25138 | 102 | 99.996 |
| 0.75″ Microfines | Non-surfactant | 36846 | 300 | 99.993 |

TABLE 4

| | | Average |
|---|---|---|
| Product | Resin | MOR (psi) |
| 0.375″ Microfines | Surfactant | 2282 |
| 0.375″ Microfines | Non-surfactant | 2203 |
| 0.625″ Microfines | Surfactant | 2109 |
| 0.625″ Microfines | Non-surfactant | 2228 |
| 0.75″ Microfines | Surfactant | 2137 |
| 0.75″ Microfines | Non-surfactant | 2145 |

1. A decorative wood composite product, comprising:
a wood composite product having a face layer comprising wood pieces bonded together with a thermosetting resin containing a surfactant; and
a decorative overlay affixed to the face layer.

2. The decorative wood composite product of claim 1 wherein the thermosetting resin is selected from the group consisting of an amino resin, a phenolic resin, and mixtures thereof.

3. The decorative wood composite product of claim 2 wherein the thermosetting resin is an amino resin and the amino resin is selected from the group consisting of a melamine-formaldehyde resin, a urea-formaldehyde resin, and mixtures thereof.

4. The decorative wood composite product of claim 2 wherein the thermosetting resin is a phenolic resin and the phenolic resin is selected from the group consisting of a phenol-formaldehyde resin, a phenol-acetaldehyde resin, a resorcinol-formaldehyde resin, a phenol-furfural resin, and mixtures thereof.

5. The decorative wood composite product of claim 4 wherein the phenolic resin is a phenol-formaldehyde resin and the phenol-formaldehyde resin is a phenolic resole resin.

6. The decorative wood composite product of claim 1 wherein the surfactant is an aliphatic hydrocarbon comprising at least 6 carbon atoms.

7. The decorative wood composite product of claim 6 wherein the aliphatic hydrocarbon is an alcohol.

8. The decorative wood composite product of claim 7 wherein the alcohol is cetyl alcohol.

9. The decorative wood composite product of claim 6 wherein the aliphatic hydrocarbon is a fatty acid.

10. The decorative wood composite product of claim 6 wherein the aliphatic hydrocarbon comprises a tall oil fatty acid.

11. The decorative wood composite product of claim 1 wherein the surfactant is selected from the group consisting of oleic acid, acetylated sucrose diester, ethylene glycol distearate, an acetylated monoglyceride, sorbitan trioleate, glycol dioleate and mixtures thereof.

12. The decorative wood composite product of claim 6 wherein the surfactant further comprises an amine.

13. The decorative wood composite product of claim 12 wherein the amine is a volatile amine.

14. The decorative wood composite product of claim 12 wherein the amine is triethylamine.

15. The decorative wood composite product of claim 1 wherein the surfactant comprises an amine and an acidic aliphatic hydrocarbon, wherein the amine and the acidic aliphatic hydrocarbon are present in a molar ratio of about 0.5 to about 1.5.

16. The decorative wood composite product of claim 15 wherein the molar ratio is about 1:1.

17. The decorative wood composite product of claim 1 wherein the surfactant comprises an amine and a fatty acid, wherein the amine and the fatty acid are present in a molar ratio of about 0.5 to about 1.5.

18. The decorative wood composite product of claim 17 wherein molar ratio is about 1:1.

19. The decorative wood composite product of claim 1 wherein the surfactant comprises triethylamine and a tall oil fatty acid.

20. The decorative wood composite product of claim 19 wherein the triethylamine and the tall oil fatty acid are present in an equivalent weight ratio of about 0.5 to about 1.5.

21. The decorative wood composite product of claim 20 wherein the equivalent weight ratio is about 1:1.

22. The decorative wood composite product of claim 1 wherein the decorative overlay is a paper.

23. The decorative wood composite product of claim 22 wherein the paper is a melamine resin-saturated paper.

24. The decorative wood composite product of claim 1 wherein the decorative overlay is a fabric.

25. The decorative wood composite product of claim 1 wherein the decorative overlay is a metal foil.

26. The decorative wood composite product of claim 1 wherein the decorative overlay is a polyester film.

27. The decorative wood composite product of claim 26 wherein the polyester film is a polyethylene film.

28. In a method of making a decorative wood composite product, wherein the decorative wood composite product comprises a face layer and a decorative overlay, the improvement comprising:
bonding wood pieces in the face layer together with a thermosetting resin containing a surfactant.

29. The method of claim 28 wherein the thermosetting resin is selected from the group consisting of an amino resin, a phenolic resin, and mixtures thereof.

30. The method of claim 29 wherein the thermosetting resin is an amino resin and the amino resin is selected from the group consisting of a melamine-formaldehyde resin, a urea-formaldehyde resin, and mixtures thereof.

31. The method of claim 29 wherein the thermosetting resin is a phenolic resin and the phenolic resin is selected from the group consisting of a phenol-formaldehyde resin, a phenol-acetaldehyde resin, a resorcinol-formaldehyde resin, a phenol-furfural resin, and mixtures thereof.

32. The method of claim 31 wherein the phenolic resin is a phenol-formaldehyde resin and the phenol-formaldehyde resin is a phenolic resole resin.

33. The method of claim 28 wherein the surfactant is an aliphatic hydrocarbon comprising at least 6 carbon atoms.

34. The method of claim 33 wherein the aliphatic hydrocarbon is an alcohol.

35. The method of claim 34 wherein the alcohol is cetyl alcohol.

36. The method of claim 33 wherein the aliphatic hydrocarbon is a fatty acid.

37. The method of claim 33 wherein the aliphatic hydrocarbon comprises a tall oil fatty acid.

38. The method of claim 28 wherein the surfactant is selected from the group consisting of oleic acid, acetylated sucrose diester, ethylene glycol distearate, an acetylated monoglyceride, sorbitan trioleate, glycol dioleate and mixtures thereof.

39. The method of claim 33 wherein the surfactant further comprises an amine.

40. The method of claim 39 wherein the amine is a volatile amine.

41. The method of claim 39 wherein the amine is triethylamine.

42. The method of claim 28 wherein the surfactant comprises an amine and a fatty acid, wherein the amine and the fatty acid are present in a molar ratio of about 0.5 to about 1.5.

43. The method of claim 41 wherein the molar ratio is about 1:1.

44. The method of claim 28 wherein the surfactant comprises triethylamine and a tall oil fatty acid.

45. The method of claim 44 wherein the triethylamine and the tall oil fatty acid are present in an equivalent weight ratio of about 0.5 to about 1.5.

46. The method of claim 45 wherein the equivalent weight ratio is about 1:1.

47. The method of claim 28 wherein the decorative overlay is a paper.

48. The method of claim 47 wherein the paper is a melamine resin-saturated paper.

49. The method of claim 28 wherein the decorative overlay is a fabric.

50. The method of claim 28 wherein the decorative overlay is a metal foil.

51. The method of claim 28 wherein the decorative overlay is a polyester film.

52. The method of claim 51 wherein the polyester film is a polyethylene film.

53. An adhesive composition suitable for bonding wood pieces together, comprising:
a thermosetting resin,
an amine; and
a tall oil fatty acid.

54. The adhesive composition of claim 53 wherein the amine is a volatile amine.

55. The adhesive composition of claim 53 wherein the amine is triethylamine.

56. The adhesive composition of claim 53 wherein the amine and the tall oil fatty acid are present in an equivalent weight ratio of about 0.5 to about 1.5.

57. The adhesive composition of claim 56 wherein the equivalent weight ratio is about 1:1.

58. An adhesive composition comprising:
a thermosetting resin;
a tall oil fatty acid; and
triethylamine in an equivalent weight ratio of about 1:1 with the tall oil fatty acid.
